(19) United States
(12) Patent Application Publication
(10) Pub. No.: US 2013/0046587 A1
(43) Pub. Date: Feb. 21, 2013

(54) SYSTEM AND METHOD FOR MANAGING PARKING RIGHTS

(71) Applicants: Dale FRASER, Calgary (CA); Allan J. BAZAR, Calgary (CA)

(72) Inventors: Dale FRASER, Calgary (CA); Allan J. BAZAR, Calgary (CA)

(21) Appl. No.: 13/656,029

(22) Filed: Oct. 19, 2012

Related U.S. Application Data
(63) Continuation of application No. 12/669,270, filed on Jan. 15, 2010.

(51) Int. Cl. G06Q 50/30

(52) U.S. Cl. 705/13

(57) ABSTRACT

The invention relates to a method for managing parking rights. It comprises receiving, from each of a plurality of users, a request for issuing a parking right, each containing a unique identifier associated with a parking area and a license plate number identifying a unique vehicle; storing, in a centralised database, each request; issuing a parking right for each of the plurality of users, including a parking right expiry time; collecting a license plate number of a vehicle for which a parking right status is to be verified and a unique identifier associated with a parking area where the vehicle is located; querying the database, by comparing the license plate number with the license plate numbers stored in the database; and determining if a parking right has been issued that corresponds to the license plate number of the vehicle. A system for managing parking rights is also disclosed.

### CROSS REFERENCE TO RELATED APPLICATIONS

This application is a continuation under 35 U.S.C. §120 of U.S. patent application Ser. No. 12/669,270, which was filed on Jan. 15, 2010 under 35 USC §371 as a national stage filing of PCT Application No. PCT/CA2007/001266 filed Jul. 18, 2007, the contents of which are hereby incorporated entirely herein by reference.

### COPYRIGHT NOTICE

Contained herein is material that is subject to copyright protection. The copyright owner has no objection to the facsimile reproduction of the patent disclosure by any person as it appears in the Patent and Trademark office patent files or records, but otherwise reserves all rights to the copyright whatsoever.

### FIELD OF THE INVENTION

The present invention relates to the field of parking rights management, and more particularly to a system and method for managing issuance and enforcement of parking rights.

### BACKGROUND OF THE INVENTION

In cities and other larger areas, municipalities are generally in charge of the management of the public roadways. The role of the municipalities is to ensure that the use of public roadways is managed in the better interests of the community as a whole. Therefore, parking regulations are enacted and enforced to implement policy defining the use of public roadways and parking areas. Purposes for which parking regulations are enacted and enforced include, easing congestion on roadways, facilitating vehicle turn-over and hence improving foot traffic for business owners.

In a business community that relies on parking for customers, frequent turn-over is necessary to sustain a flow of new customers. Therefore, municipalities try to ensure that convenient space is reserved for use of as many as possible, the short stay parker. To do so, municipalities discourage long stay parking through the use of several tools, including pricing, time limit purchase restrictions and enforcement. As a result, parking users are often required to pay a fee to park on the curb spaces or on parking lots at allowable times, which is usually based on an hourly fee structure. Fee for use systems generally rely on parking meter technology. Parking meters are generally installed so that they are located beside each parking spot that is associated with a fee for use system. A parking user rents time from the parking meter by adding currency to the meter. The parking meter then displays the amount of time for which a vehicle may be parked in a specific parking space. While many people have grown accustomed to the use of parking meters, parking meters are difficult to upkeep and expensive to install, as each parking space requires a parking meter.

Many municipalities have begun to use other technologies to replace parking meters. One such technology involves the use of a user purchasing a ticket from a centralized machine that may be found at specific locations near a group of parking spaces. When the appropriate currency is deposited into the machine, the centralized machine prints a ticket, which sets out the time until which a vehicle may park in that location. The parking user displays the parking ticket in the vehicle such that it is visible to a parking enforcement officer.

In order to enforce fee for use systems, parking enforcement officers are relied upon. The parking enforcement officer monitors each vehicle parked in each parking space, by either verifying the parking meter, or the parking ticket displayed. This requires a great deal of manual effort, and the parking enforcement officer's efforts are often hampered by weather conditions, leaving the enforcement officer prone to injury as they are continuously walking between vehicles. The use of parking enforcement officers is also inefficient, as a parking enforcement officer is only able to cover a limited number of cars in a given shift.

As a result, systems and method for managing parking rights and detecting parking infractions have been developed. Known prior art system include Canadian Patent No. 2,511,461, issued Feb. 27, 2007, wherein a wireless network covering a large local geographical area is used to link a large number of payment terminals provided in the same area. In particular, parking data is gathered from parking user at the payment terminals and is sent from the payment terminals to the wireless network. Then, the wireless network is used to transmit the parking data upon receipt from the payment terminals to the portable terminals in the local geographical. While this system may fulfill its particular objective, it is still not optimal. In particular, the system of '461 does not propose a centralised system that allows the storage of the parking data in a centralised database, the centralised database being queried each time a parking right status need to be verified.

Therefore, there is a need in the art for a method and system of managing parking rights that addresses at least some of the inconveniences described above.

### SUMMARY OF THE INVENTION

It is an object of the present invention to provide a method of managing parking rights by using information regarding vehicle license plate numbers and corresponding parking areas stored in a centralised database.

It is also an object of the present invention to provide a parking rights management system having a centralised database storing information regarding vehicle license plate numbers and corresponding parking areas.

In accordance with an aspect there is provided a method of managing parking rights comprising: receiving, from each of a plurality of users, a request for issuing a parking right, each request containing a unique identifier associated with a parking area and a license plate number identifying a unique vehicle; storing, in a centralised database, the unique identifier associated with the parking area and the license plate number identifying the unique vehicle of each request; issuing, based on each received request, a parking right for each of the plurality of users, the parking right including a parking right expiry time by: linking, in the centralised database, the parking right expiry time, the unique identifier associated with the parking area and the license plate number identifying the unique vehicle for each of the parking right issued; ascertaining a license plate number of a vehicle for which a parking right status is to be verified; querying the centralised database by comparing the license plate number of the vehicle for which the parking right status is to be verified, with license plate numbers stored in the centralised database; and determining if a parking right has been issued that corresponds to the license plate number of the vehicle for which the parking right status is to be verified.

In an embodiment, determining if the parking right has been issued that corresponds to the license plate number of the vehicle for which the parking right status is to be verified comprises: should the license plate number of the vehicle for which the parking right status is to be verified match one of the license plate numbers stored in the centralised database: comparing the unique identifier associated with the parking area where the vehicle for which the parking right status is to be verified is located with the unique identifier associated with the parking area linked with the corresponding license plate number stored in the centralised database; generating a parking right infraction flag should the unique identifier associated with the parking area where the vehicle for which the parking right status is to be verified is located match the unique identifier associated with the parking area linked with the corresponding license plate number stored in the centralised database and the parking right expiry time linked with the corresponding license plate number stored in the centralised database be exceeded; generating a parking right infraction flag should the unique identifier associated with the parking area where the vehicle for which the parking right status is to be verified is located not match the unique identifier associated with the parking area linked with the corresponding license plate number stored in the centralised database; and generating a parking right infraction flag should the license plate number of the vehicle for which the parking right status is to be verified not match any of the license plate numbers stored in the centralised database.

In an embodiment, the receiving, from each of the plurality of users, the request for issuing the parking right further comprises: registering, in the centralised database, the license plate number identifying the unique vehicle and a unique identifier of a communication device of a user to identify the user of the communication device, the license plate number identifying the unique vehicle and the unique identifier of the communication device being linked together in the centralised database; and requesting the issuance of the parking right, when the unique identifier associated with the parking area in the centralised database is transmitted by the communication device.

According to another aspect, there is provided a parking rights management system comprising: a receiving component receiving, from each of a plurality of users, a request for issuing a parking right, each request containing a unique identifier associated with a parking area and a license plate number identifying a unique vehicle; a centralised database where the unique identifier associated with the parking area and the license plate number identifying the unique vehicle of each request is stored, the receiving component communicating with the centralised database; a parking right issuing component issuing, based on each received request, a parking right for each of the plurality of users, the parking right including a parking right expiry time, the parking right issuing component linking, in the centralised database, the parking right expiry time, the unique identifier associated with the parking area and the license plate number identifying the unique vehicle for each parking right issued, the parking right issuing component communicating with the centralised database; a license plate number collecting component collecting a license plate number of a vehicle for which a parking right status is to be verified, the license plate number collecting component communicating with the centralised database; and an enforcement component querying the centralised database by comparing the license plate number of the vehicle for which the parking right status is to be verified, with license plate numbers stored in the centralised database, the enforcement component further determining if a parking right has been issued that corresponds to the license plate number of the vehicle for which the parking right status is to be verified.

According to another aspect, there is provided a method of managing parking rights comprising: receiving, from each of a plurality of users, a request for issuing a parking right, each request containing a unique identifier associated with a parking area and a license plate number identifying a unique vehicle; storing, in a centralised database, the unique identifier associated with the parking area and the license plate number identifying the unique vehicle of each request; issuing, based on each received request, a parking right for each of the plurality of users, the parking right including a parking right expiry time by: linking, in the centralised database, the parking right expire time, the unique identifier associated with the parking area and the license plate number identifying the unique vehicle for each of the parking right issued; querying the centralised database by providing to the centralised database a unique identifier associated with a parking area for which a parking right status of a vehicle parked in the parking area associated with the unique identifier is to be verified; and returning a license plate number and a parking right expiry time linked to the unique identifier associated with the parking area in the centralised database.

According to another aspect, there is provided a parking rights management system comprising: a receiving component receiving, from each of a plurality of users, a request for issuing a parking right, each request containing a unique identifier associated with a parking area and a license plate number identifying a unique vehicle; a centralised database where the unique identifier associated with the parking area and the license plate number identifying the unique vehicle of each request is stored, the receiving component communicating with the centralised database; a parking right issuing component issuing, based on each received request, a parking right for each of the plurality of users, the parking right including a parking right expiry time, the parking right issuing component linking, in the centralised database, the parking right expiry time, the unique identifier associated with the parking area and the license plate number identifying the unique vehicle for each parking right issued, the parking right issuing component communicating with the centralised database; and an enforcement component querying the centralised database by providing to the centralised database a unique identifier associated with a parking area for which a parking right status of a vehicle parked in the parking area associated with the unique identifier is to be verified, the centralised database returning to the enforcement component a license plate number and a parking right expiry time linked to the unique identifier associated with the parking area in the centralised database.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of the embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 depicts a data model of a parking rights management system, according to an embodiment of the invention;

FIG. 2 depicts an enforcement graphical user interface for managing enforcement of parking rights, according to an embodiment of the invention;

FIG. 3 depicts a flowchart of a method of issuing parking rights, according to an embodiment of the invention;

FIG. 4 depicts a flowchart of a method of issuing parking rights, according to another embodiment of the invention; and

FIG. 5 depicts a flowchart of a method of enforcing parking rights, according to an embodiment of the invention.

### DETAILED DESCRIPTION OF THE PREFERRED EMBODIMENTS

To overcome the limitations noted above, the present invention is directed to a method and system of managing parking rights. In particular, the present invention is designed to offer municipalities, operators, contractors to municipalities, a consortium of municipalities or a consortium of operators a better way to manage parking both at the curb side and in parking lots. The present invention offers the management of parking area where a payment for parking is required as well as management of parking area where no payment is required. In addition the present invention can co-exist with traditional parking meters, pay and display systems, pay by space systems and permit required systems.

As noted above, a parking area is intended to encompass a single parking space, a number of parking spaces, an entire area of a city, a single parking lot and a number of parking lots.

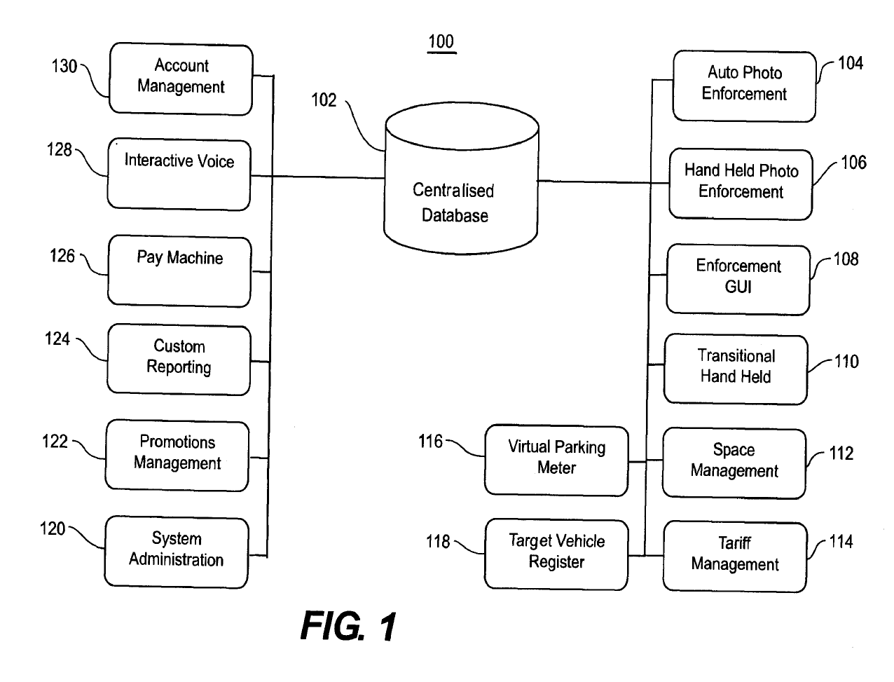

FIG. 1 schematically depicts the data model of a parking rights management system 100, according to an embodiment of the invention. The parking rights management system 100 is designed to reside in an environment that has fully redundant servers and synchronized databases in a standard operating environment. The parking rights management system 100 is based on a centralised database 102 and therefore employs the principles of a central data repository and a single source of record. Throughout the parking rights management system 100, data is never replicated but referenced by coupled modules which are linked to the centralised database 102. Being modular in design the parking rights management system is capable of upgrades and enhancements without requiring re-engineering of the parking rights management system 100. The parking rights management system 100 comprises, in an embodiment of the invention, namely, an auto photo enforcement module 104, an hand held photo enforcement module 106, an enforcement graphical user interface module 108, a transitional hand held module 110, a space management module 112, a tariff management module 114, a virtual parking meter module 116, a target vehicle register module 118, a system administration module 120, a promotions management module 122, a custom reporting module 124, a pay machine module 126, an interactive voice module 128 and an account management module 130. It is contemplated that other modules, such as a financial management module, could be added to the parking rights management system 100 to meet the particular needs of users and operators of the system.

It should be appreciated that all of the above mentioned modules are in communication and synchronized with the centralised database 102 via a transmission channel. In addition, it should be understood that other additional modules may be added to the parking rights management system without departing from the spirit of the invention.

The centralised database 102 is used to store the requests for issuing parking rights received from users, each request containing a unique identifier associated with a parking area, such as an alphanumerical code (e.g. A1, K6), and a license plate number identifying a unique vehicle. The unique identifier associated with the parking area is communicated to the parking user through the use of customized traffic devices or signs. As a transitional disposition, the unique identifier associated with a parking area may also be communicated to the parking user through the placement of a decal on parking meters, pay and display systems, pay by space systems and permit required systems. In addition, the centralised database 102 is used to issue a parking right to the user, including a parking right expiry time, by linking, in the centralised database 102, the unique identifier associated with the parking area, the license plate number identifying the unique vehicle and the parking right expiry time. The parking right expiry time may be determined by an amount of time purchased by the user, or in the case of a parking area where no payment is required, by a policy defined by the municipality.

The virtual parking meter module 116 is intended to be an interface between the parking user and the centralised database 102. The virtual parking meter module 116 issues parking rights to the users by transferring to the centralised database 102 information transmitted by the parking users. The virtual parking meter module 116 can be activated by a number of different ways through the use of the account management module 130, the interactive voice module 128 and the pay machine module 126, alone or in combination. By using the virtual parking meter module 116, the parking users do not have to retain confirmation of the issuance of the parking right thereby avoiding the necessity to display any proof of activation of the virtual parking meter module 116.

The pay machine module 126 is designed to allow parking users to initiate a parking session on street or in a parking lot. The pay machine module 126 may include, in an embodiment of the invention, a curb side machine, the curb side machine having a user/machine interface and specific embedded software in order to carry transactions and transmit information to the centralised database 102. The user/machine interface includes keyboard, screen, touch-screen and any other device allowing a user to enter information. Since the curb side machine is in communication with the centralised database 102, there is no need to install a curb side machine dedicated to a specific parking area thereby alleviating issues when a curb side machine fails. In such a case, parking users are simply redirected to another nearby curb side machine. Furthermore, when a user wishes to extend the expiry time of an already issued parking right, the user may simply use the closest curb side machine, without returning to the curb side machine adjacent to where the vehicle of the user is parked. The parking user requests a parking right to the virtual parking meter module 116, through the curb side machine, by entering on the user/machine interface the unique identifier associated with the parking area, the license plate number identifying the vehicle of the user and an amount of time to be purchased determining the parking right expiry time. Components to receive payment are also provided with the curb side machine, allowing the user to make a payment by coin, payment card, debit card or other payment method. In another embodiment of the invention, the curb side machine can be dedicated to a specific parking area by pre-programming the unique identifier associated with the parking area. In such a case, the parking user requests a parking right to the virtual parking meter module 116 through the curb side machine by entering, on the user/machine interface, the license plate number identifying the vehicle of the user and an amount of time to be purchased determining the parking right expiry time. Since the parking users do not have to retain confirmation of the issuance of the parking right, there is no necessity to display any proof of activation of the virtual parking meter module 116.

The account management module 130 offers to the parking user the possibility to create and update an account that can be reused over time. In an embodiment of the invention, the account is an online account, having an identification number, that can be managed over the Internet or by a voice interface system. The account management module 130 manages the parking user accounts. In an embodiment of the invention, the account management module 130 is a web-service accessible by any web-enabled device. A parking user can access the online account through the account management module 130 to enter or modify license plate number identifying vehicles, and personal information. Several license plate numbers, each identifying a unique vehicle, can be linked to a same online account thereby allowing a parking user to manage issuance of parking rights for several vehicles with a unique online account. In addition, the account management module 130 allows a parking user to enter and modify contact information, perform online account inquiries, confirm previous transactions and make payments in order to credit the online account. Payment methods include credit and debit cards while on-line, but also include cash, cheque, money order, or any other financial instrument when in person. In addition, the parking user may use the online account to register a unique identifier of a communication device to be associated with a license plate number identifying a unique vehicle. It should be appreciated that the parking user may register several unique identifiers of communication devices (each identifying a unique identifier of communication device) to be associated with a license plate number identifying a unique vehicle. It should also be appreciated that the parking user may register a unique identifier of a communication device to be associated with several license plate numbers (each identifying a unique vehicle). It should further be appreciated that the parking user may register several unique identifiers of communication devices (each identifying a unique identifier of a communication device) to be associated with several license plate numbers (each identifying a unique vehicle). The account management module 130 further allows parking user to report transactions associated with the online account of the user for a specified period of time. The generated online account report can be exported and sent by email at any time via an account folder for further analysis, expense reporting and income tax requirements. In addition, control parameters surrounding warnings the parking user wishes to receive can be configured into the online account. Warnings include, for example, notification prior to the expiry time of an issued parking right, notification of pending parking restrictions affecting a parking area, low account balances, notification of vehicle impoundment, notification of pending permit expiry. Warnings can be sent to the parking user by voice message, email, text message or any other communication method.

Furthermore, the account management module 130 can be used by fleet account holders to manage multiple license plate accounts. Therefore, by monitoring transactions recorded in the centralised database 102, a fleet manager using the account management module 130 can monitor parking locations of the vehicles of the fleet. Additional functionalities of the account management module 130 are to offer the fleet manager reports by location format or by real time graphical map based interface. These additional functionalities can be used to supplement or replace dispatch monitoring services or to alarm fleet managers to ensure the vehicles of their fleet avoid parking infractions. In a case, where several vehicles are linked to a same online account, a flat rate online account based on an annual or monthly fee can be used. In this case, parking users parking a vehicle of a registered fleet may not have to request the issuance of a parking right by using the virtual parking meter module 116.

Through the account management module 130 and the promotions management module 122, parking promotions and incentives can be sent to parking users having an online account. Promotions can be one-time parking discounts in dollars or percent of parking fees, time limited or limited to a number of applications for each discount or to an amount of money. These promotions can be targeted to certain groups of users based on information provided by the users in their accounts. For example discounts could be offered to seniors, veterans, etc. Promotions can also be based on vehicle type of the corresponding license plate number stored with the online account. For example, discounts could be offered to users of sub-compact or hybrid vehicles. Furthermore, the parking rights management system 100 allows merchants to create a promotion of their choosing by setting up an online account and choosing the characteristics of their promotion through the account management module 130. These promotions would encourage parking in parking areas in the vicinity of the merchants' businesses which in turn may increase business for these merchants. Characteristics of their promotion include duration of the promotion, an amount of parking discount, availability and a maximum cost to the merchant of the promotion. Once the merchant has completed and paid for the promotion, the parking rights management system 100 generates a series of one time promotional code numbers for distribution to customers by the merchant. A generic time limited unique promotional code number that can be published and used by any registered parking user in certain area for certain time periods can also be used as an incentive. Promotional code numbers generated by merchant can also be used by inputting the code(s) into the web-based system to supplement parking user account balances or to reduce the cost of a parking right already issued. A promotion code may also be inputted via the mobile communication device during an active parking right to enable a discount or provide additional parking rights.

The interactive voice module 128 is used by the parking user to activate and deactivate the virtual parking meter module 116 through the use of either a land-line phone or a mobile phone. In order to use the interactive voice module 128, the parking user has to first create an online account by using the account management module 130. During the online creation process, the parking user enters a license plate number identifying a unique vehicle, a unique identifier of a communication device, in this case a phone number, and a preferred payment method. Therefore, by creating the online account through the account management module 130, the parking user needs only to dial a phone number associated with an interactive server of the interactive voice module 128. Once the phone connection is established between the land-line or mobile phone of the parking user and the interactive server of the interactive voice module 128, the parking user enters the unique identifier associated with the parking area where the vehicle of the parking user is located. The account management module 130 recognizes the unique identifier of the land-line or mobile phone of the parking user, thereby identifying the parking user and transmitting the license plate number associated therewith identifying the parking user vehicle and the unique identifier associated with the parking area to the virtual parking meter 116. In the case where more than one license plate number is associated with the phone, the user is prompted to select the one for which a parking right is to be requested. The virtual parking meter 116 then consults the space management module 112 and the tariff management module 114 to assign a maximum amount of time defining the expiry time of the parking right requested. Thereafter, the virtual parking meter 116 transmits to the centralised database 102 the request for issuing the parking right. The centralised database 102 issues the parking right to the parking user, including the parking right expiry time, by linking, in the centralised database 102, the unique identifier associated with the parking area, the license plate number identifying the unique vehicle and the parking right expiry time. In an embodiment of the invention, the parking user receives, through the interactive voice module 128, information related to the parking right expiry time. When the parking user leaves the parking space, before the end of the parking right expiry time, the parking user may deactivate the virtual parking meter 116. Similarly to the activation, the parking user needs only to dial the phone number associated with the interactive server of the interactive voice module 128 to confirm that the parking session is now concluded and that the parking right issued to the parking user can be withdrawn. The parking rights management system 100 modifies, in the centralised database 102, the parking right expiry time to reflect the conclusion of the parking session. Any residual time remaining is credited back to the parking user through his online account managed by the account management module 130.

Furthermore, the interactive voice module 128 can be used without the parking user having to first create an online account through the account management module 130. In such a case, the interactive voice module 128 is used in the same way as the pay machine module 126. The parking user dials the phone number associated with the interactive server of the interactive voice module 128 and enters the unique identifier associated with the parking area, the license plate number identifying the unique vehicle, the parking right expiry time, and payment information. Thereafter, the virtual parking meter 116 transmits to the centralised database 102 the request for issuing the parking right. The centralised database 102 issues the parking right to the parking user, including the parking right expiry time, by linking, in the centralised database 102, the unique identifier associated with the parking area, the license plate number identifying the unique vehicle, and the parking right expiry time.

Another way to activate the virtual parking meter 116 is through the use of a web-enabled device. Such a web-enabled device is preferably a personal digital assistant, a vehicle navigation system and more generally any device able to exchange data over the Internet. The web-enabled device is used by the parking user to activate and deactivate the virtual parking meter module 116 by transmitting data to the parking rights management system 100. In order to use the web-enabled device to issue a parking right, the parking user has to first create an online account by using the account management module 130. It should be understood that the online account may be created and updated by using the web-enabled device. During the online creation process, the parking user enters a license plate number identifying a unique vehicle, a unique identifier of a communication device, in this case a unique identifier of the web-enabled device, and a preferred payment method. The unique identifier of the web-enabled device can be a phone line number, an IP address, a mac address and more generally any identification protocol allowing to uniquely identify the web-enabled device. Therefore, by creating the online account through the account management module 130, the parking user needs only to send a data request from the web-enabled device to the parking rights management system 100 requesting for establishing a connection between the web-enabled device and the parking rights management system 100. Once the connection is established, the parking user enters the unique identifier associate with the parking area where the vehicle of the parking user is located. The account management module 130 recognizes the unique identifier of the web-enabled device of the parking user thereby identifying the parking user and transmitting the license plate number associated therewith identifying the parking user vehicle and the unique identifier associated with the parking area to the virtual parking meter 116. In the case where more than one license plate number is associated with the web-enabled device, the user is prompted to select the one for which a parking right is to be requested. The virtual parking meter 116 then consults the space management module 112 and the tariff management module 114 to assign a maximum amount of time defining the expiry time of the parking right requested. Thereafter, the virtual parking meter 116 transmits to the centralised database 102 the request for issuing the parking right. The centralised database 102 issues the parking right to the parking user, including the parking right expiry time, by linking, in the centralised database 102, the unique identifier associated with the parking area, the license plate number identifying the unique vehicle and the parking right expiry time. In an embodiment of the invention, the parking user receives, through the web-enabled device, information related to the parking right expiry time. When the parking user leaves the parking space, before the end of the parking right expiry time, the parking user may deactivate the virtual parking meter 116. Similarly to the activation, the parking user needs only to establish a connection between the web-enabled device and the parking rights management system 100 in order to confirm that the parking session is now concluded and that the parking right issued to the parking user can be withdrawn. The parking rights management system 100 modifies, in the centralised database 102, the parking right expiry time to reflect the conclusion of the parking session. Any residual time remaining is credited back to the parking user through his online account managed by the account management module 130.

Furthermore, the web-enabled device can be used without the parking user having to first create an online account through the account management module 130. In such a case, the web-enabled device is used on the same way than the pay machine module 126. The parking user establishes a connection between the web-enabled device and the parking rights management system 100 and enters the unique identifier associated with the parking area, the license plate number identifying the unique vehicle, the parking right expiry time, and payment information. Thereafter, the virtual parking meter 116 transmits, to the centralised database 102, the request for issuing the parking right. The centralised database 102 issues the parking right to the parking user, including the parking right expiry time, by linking, in the centralised database 102, the unique identifier associated with the parking area, the license plate number identifying the unique vehicle, and the parking right expiry time.

The enforcement of the parking rights is managed through the auto photo enforcement module 104, the hand held photo enforcement module 106, and the transitional hand held module 110. In the preferred embodiment of the invention, the modules 104 and 106 collect photos of vehicle for which parking right status is to be verified and unique identifier associated with parking area where the vehicle is located. Next, the centralised database 102 of the parking rights management system 100 is queried, by comparing the license plate number of the vehicle for which the parking right status is to be verified, with the license plate numbers stored in the centralised database 102 in order to determine a violation. The violation determination can be performed on a real time basis by connecting the auto photo enforcement module 104 and the hand held photo enforcement module 106 to the centralised database 102 via a wireless connection. In addition, the violation determination can also be realised at a later time, by comparing the collected photo to the centralised database 102 by using the enforcement graphical user interface module 108 described in greater detail below. The enforcement graphical user interface module 108 allows enforcement personnel discretion when determining if an infraction has occurred that warrants a parking ticket. Collected photos along with data contained in the centralised database 102 are later used as evidence for prosecution in traffic court when violation are contested and are available online as a customer, by the account management module 130 for example. Furthermore, a ticket payment interface module can be linked to the parking management system 100 that allows for immediate online payment of photo enforcement infractions when they are uncontested.

The auto photo enforcement module 106, in the preferred embodiment, is a customized cameras system that is mounted on an enforcement vehicle such as a car, including an infra red and a global positioning system (GPS). The customized cameras system records the presence of vehicles in parking areas and captures one, two, or more images of the vehicles per patrol. In the preferred embodiment of the invention, two images are captured for each vehicle, a first image is the vehicle profile (side view) and a second image is the vehicle license plate. Additionally, GPS location, date, time, enforcement personnel identification number, vehicle size, and the unique identifier associated with the parking area are stored with the images in a database.

The hand held photo enforcement module 106, in the preferred embodiment, is a portable device that can be handled by employment personnel to collect license plate numbers when license plates are not visible to the auto photo enforcement module 104. Such cases include motorcycle which park license plates facing the curb, and certain vehicles that have their license plates obstructed by trailer hitches. In the preferred embodiment, the hand held photo enforcement module is a web-enabled device such as a personal digital assistant that can include a camera to capture images of the vehicles.

The transitional hand held module 110 can be used where the parking rights management system 100 is used in conjunction with traditional parking meters, pay and display systems, and pay by space systems. The transitional hand held module 110 is then used by the enforcement personnel to access the central database 102 in real time. The transitional hand held module 110 queries the central database 102 by specific identifier associated with a parking area being patrolled, the central database 102 returns a list of all license plate numbers, the province/state of the license plates and an expiry time for which parking rights have been issued. Those vehicles without time on their meters, parking coupons on display, parking space payment indicators, or reside in the target vehicle register module 118, must show a valid parking right issued by the parking management system 100 or they are in violation for failure to purchase parking right.

In order to identify a violation and to determine if a parking right has been issued that corresponds to the license plate number of the vehicle for which the parking right status is to be verified, the parking management system 100 compares the parking right issued by the centralised database 102 to the images captured by the auto photo enforcement module 104 or the hand held photo enforcement module 106. When a license plate number, automatically or manually extracted from the captured images, cannot be matched to a parking right issued by the centralised database 102, or if two or more pictures of the vehicle identified by the license plate number confirm the vehicle has remained in a location for longer than identified as maximum on the space management module 112, a violation has occurred.

In order to manage other cases that may occur, a target vehicle register module 118 is linked to the parking rights management system 100. The target vehicle register module 118 comprises a listing of target vehicles. Target vehicles include, for example, scofflaws, reported stolen vehicles, exempt vehicles, and permit holders. Scofflaws are target vehicles that may warrant further investigation or trigger increased levels of enforcement. The parking rights management system 100 allows a parking ticket threshold to be set whereupon subsequent violations generate an alarm. Stolen vehicles generate alarms for follow-up action. Certain types of exempt vehicles do not generate a violation when the violation of a type that the exempt vehicle is exempt from. Permit holders are vehicles that have certain exemptions. In such a case, the parking rights management system 100 manages the permit issuance, expiry dates, and fees, if applicable, as the permit becomes linked to a license plate number, negating the need for rear view mirror hang tags or windshield decals.

While the parking management system 100 is capable of applying the rules for parking within regulations systematically, the process is relatively linear without regard to the discretion normally exercised by enforcement personnel. The parking management system 100 offers a measure of systematic infraction identification along with adjustable control values that can be set by a system administrator through the system administration module 120. Finally for more control over infraction identification and to address unusual circumstances, the parking management system 100 offers a way to elevate the level of information available to enforcement personnel through the enforcement graphical user interface module 108.

Enforcement personnel interface with the parking management system 100 by using the enforcement graphical user interface module 108 that allows them to visually see all of the events associated with a specific license plate number for a given period of time.

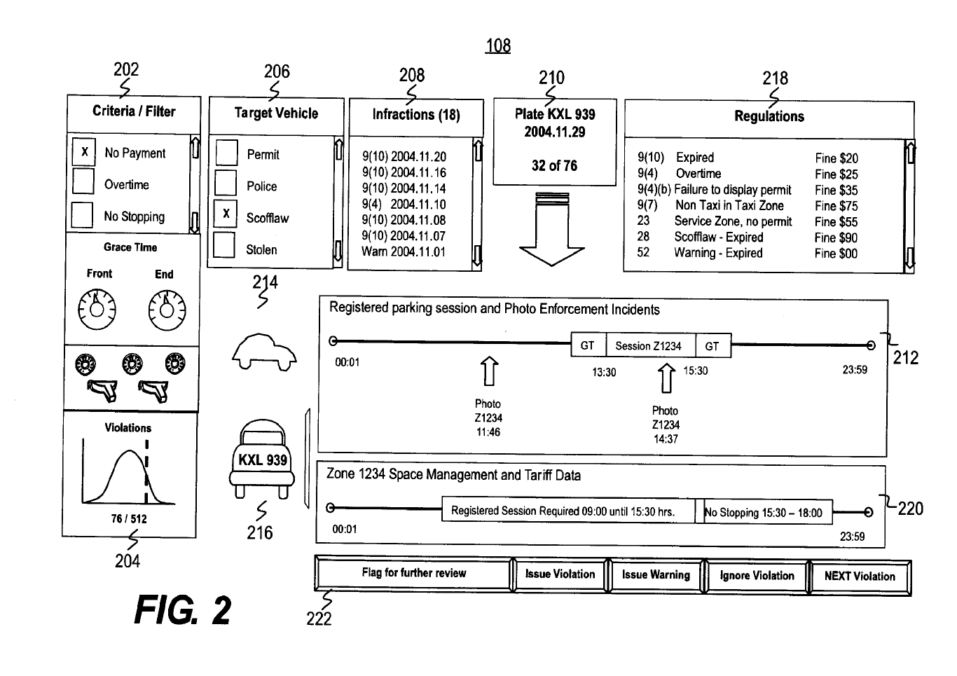

An embodiment of the enforcement graphical user interface module 108 is depicted in FIG. 2. The enforcement graphical user interface module 108 allows enforcement administration to set policy with respect to a level of enforcement necessary for their environment. Violations are managed by selecting a series of customizable data filters 202 that selects potential violations by type. In this way, the enforcement graphical user interface module 108 aims to manage the level of enforcement seeking to address the non-compliant and enabling discretion to be applied in a consistent and auditable way that meets management policy. Different policy can be adapted by the enforcement graphical user interface module 108. A violation window 204 depicts the bell curve of the normal distribution of the violations. The violation window 204 is updated each time a criteria of the customizable data filters 202 is modified. Therefore, violation criteria can be adjusted to focus on a certain amount of violators who are more abusive of policy as established by management.

The target vehicle listing 206 is also a mitigating factor in determining violations. Through selections in the target vehicle listing 206, certain types of violations may be ignored automatically due to a license plate status stored in the target vehicle register module 118. In other cases, permit notwithstanding for example, a violation may still have occurred. Furthermore, enforcement personnel can review the history of past infraction occurrences, through an infraction listing 208, to determine if the vehicle has prior tickets or warnings and to access information related to the date, type and warnings of prior tickets or warnings. Next, the enforcement personnel examines the registered parking sessions and photo enforcement incidents interface 212 that depicts the periods of time for which a parking user has an issued parking right in a specific area for a specific day when compared with photo enforcement events. Front end grace time can be allowed at the beginning of every parking session to allow for the time, after parking, that it takes to issue a parking right. Back end grace time can also be offered to allow the parking user to exit the parking area. The front end grace time and the back end grace time can be adjusted in accordance with predetermined policy. A zone information interface 220, linked to the space management module 112 and to the tariff management module 114, is offered to illustrate when parking is allowed, if blocked periods of time exist when parking is not allowed, and periods of time when rates apply. After identifying potential violations, the enforcement personnel can re-examine the image of the vehicle profile 214 and the image of the license plate 216. The enforcement personnel also has an access to a regulation interface 218 containing a list of potential infractions to be selected after considering all factors. When the appropriate infraction has been selected through the regulation interface 218, the enforcement personnel can choose the action to be executed by clicking on one of a set of buttons 222 describing actions. For example, by clicking on the flag for future review button, the enforcement personnel can continue processing potential violations and then return to the flagged incidents for supervisor consideration. In addition, by clicking on the next violation button, the enforcement personnel reviews the subsequent license plate number that is potentially in violation. After all potential violations are reviewed, the parking management system 100 creates a batch file with unique ticket numbers and integrates seamlessly to compatible back office systems that most municipalities have to process violations and fine payments. The administrator can choose, through the system administration module 120, to have all potential infractions reviewed through the enforcement graphical user interface 108, or just those that meet specific parameters that have been set by the administrator.

Furthermore, the parking rights management system 100 uses an auditable warning and ticket issuance control system that allows enforcement agencies to establish consistent enforcement policies. The warning ticket is logged into a database as a regular ticket and data is available to determine if a previous warning has been issued and for what kind of infraction.

In the preferred embodiment of the invention, the enforcement and subsequent violation notification of the parking rights management system 100 is not occurring in real time but is a batch process and is anticipating access to vehicle registry information or in-house vehicle owner information being assessable by license plate number to either the parking rights management system 100 or the ticket processing system that most agencies currently have.

Returning now to FIG. 1, the system administration module 120 and the custom reporting module 124 will be described in more detail. As described above, the system administration module 120 is linked to the centralised database 102. The system administration module 120 offers the ability to adjust system control values used for report parameters and business functionality, enforcement levels, data retention schedules, as well as creation and managing of user accounts and passwords.

The custom reporting module 124 allows for custom reporting by using all data contained in centralised database 102 of the parking rights management system 100. Routine business requirement reporting is built into the custom reporting module 124. Therefore, reports can be automatically generated, such as transactions analysis, enforcement, use of parking area, permit abuse, and individual parking user account reports. From these reports, all of the necessary requirements to routinely support an independent audit are readily available. In addition to the business requirements reporting tools, the custom reporting module 124 offers an ad hoc reporting system that allows non-developers to create, save and share, with other users of the parking rights management system 100, any custom reports on any data residing on the centralised database 102. Ad hoc reporting allows for independent queries of system-wide data elements that assist in detailed parking management analysis.

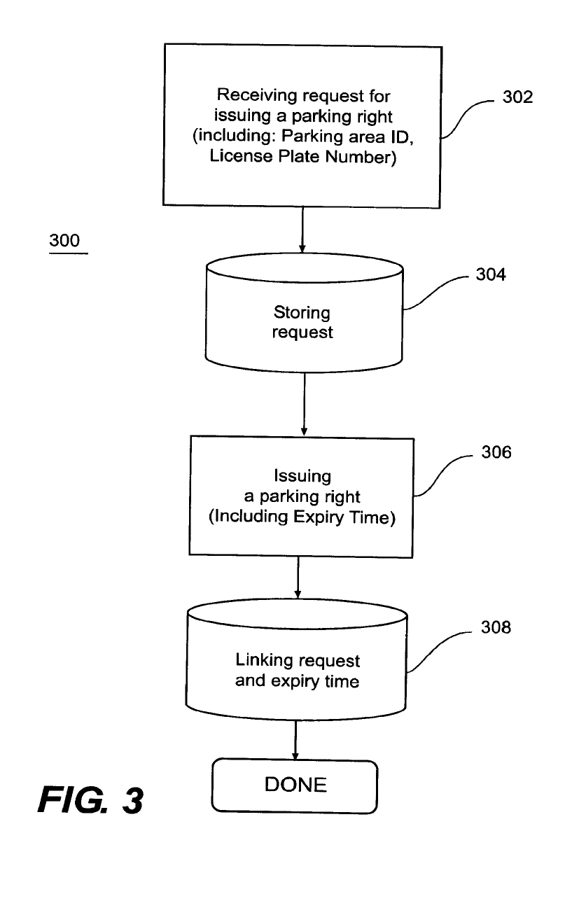

Reference is now being made to FIG. 3, where the steps of a method of issuing parking rights 300 are shown. The method of issuing parking rights 300 is undertaken for each parking user requesting issuance of a parking right. The method of issuing parking rights 300 begins at step 302, where the parking rights management system 100 receives, from each of the plurality of users, a request for issuing a parking right. As previously described, each request contains a unique identifier associated with a parking area and a license plate number identifying a unique vehicle. Method 300 then stores, at step 304, in the centralised database 102, each request. Next, the parking rights management system 100 issues, based on each request, a parking right for each of the plurality of users, including a parking right expiry time, at step 306. The parking rights management system 100 issues the parking right by linking in the centralised database 102, at step 308, the parking right expiry time, the unique identifier associated with the parking area, and the license plate number identifying the unique vehicle for each of the plurality of users. The method of issuing parking rights 300 terminates after step 308 where the parking right is issued to the parking user.

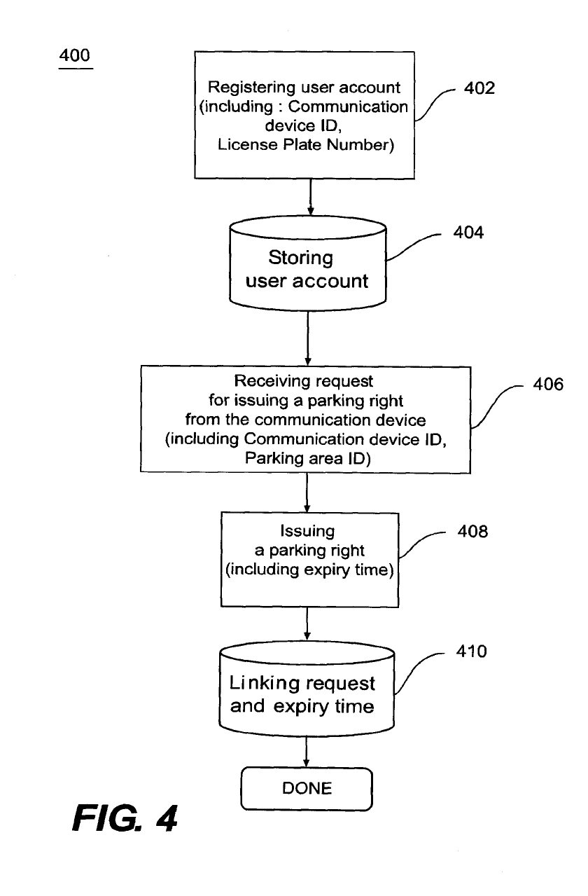

An alternative embodiment is depicted in FIG. 4, where the steps of a method of issuing parking rights 400 are shown. The method of issuing parking rights 400 is undertaken for each parking user requesting issuance of a parking right. The method of issuing parking rights 400 begins at step 402 where a parking user creates a user account, by registering, in the centralised database 102, a license plate number identifying a unique vehicle and a unique identifier of a communication device, the license plate number identifying the unique vehicle and the unique identifier of the communication device being linked together in the centralised database 102, at step 404, when the parking rights management system 100 stores the user account. This step only needs to be done once for each user, but the user account can later be updated by the user to reflect changes in the information originally provided. Next, at step 406, the parking rights management system 100 receives, from the communication device, a request for issuing a parking right. As previously described, the request contains the unique identifier of the communication device and a unique identifier associated with a parking area. The parking rights management system 100 issues, based on the request, a parking right to the user, including a parking right expiry time, at step 408. The parking rights management system 100 issues the parking right by linking in the centralised database 102, at step 410, the parking right expiry time, the unique identifier associated with the parking area and the license plate number identifying the unique vehicle corresponding to the unique identifier of the communication device stored in the centralised database 102. The method of issuing parking rights 400 terminates after step 410 where the parking right is issued to the parking user.

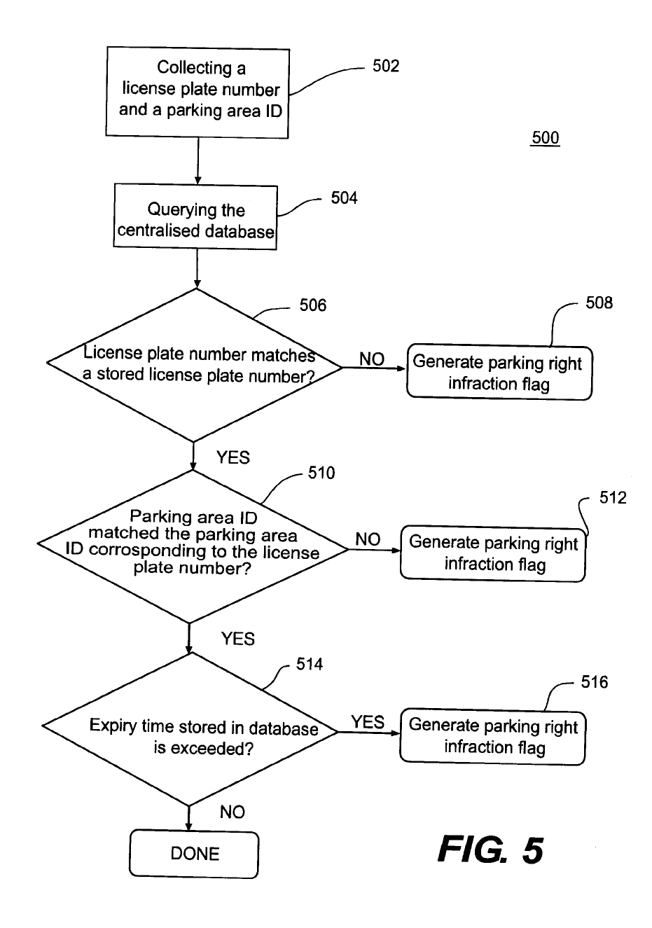

Reference is now made to FIG. 5, where the steps of a method of enforcing parking rights 500 are shown. The method of enforcing parking rights 500 is undertaken for each vehicle for which the parking right status is to be verified. The method of enforcing parking rights 500 begins at step 502 where a license plate number of a vehicle for which a parking right status is to be verified and a unique identifier associated with a parking area where the vehicle for which the parking right status is to be verified is located are collected. Next, at step 504, the centralised database 102 is queried by comparing the license plate number of the vehicle for which the parking right status is to be verified, with the license plate numbers stored in the centralised database 102. Then, the method of enforcing parking rights 500 determines, at steps 506-516, if a parking right has been issued which is still valid that corresponds to the license plate number of the vehicle for which the parking right status is to be verified. The step 506 of the method 500 determines if the license plate number of the vehicle for which the parking right status is to be verified matches one of the license plate numbers stored in the database 102. If no match can be found, then the method 500 terminates at step 508 by generating a parking right infraction flag. If a match can be found, the method 500 proceeds to step 510. The step 510 compares the unique identifier associated with the parking area where the vehicle for which the parking right status is to be verified is located with the unique identifier associated with the parking area linked with the corresponding license plate number stored in the centralised database 102. If the two parking areas do not match, then the method 500 terminates at step 512 by generating a parking right infraction flag. If a match can be found, the method 500 proceeds to step 514. The step 514 of the method 500 determines if the parking right expiry time linked with the corresponding license plate number stored in the centralised database 102 is exceeded. If the parking right expiry time is exceeded, then the method 500 terminates at step 516 by generating a parking right infraction flag. The method of enforcing parking rights 500 terminates after step 514 if no parking right infraction flag has been generated. If a parking right infraction flag is generated at either one of steps 508, 512, or 516, then a parking ticket is issued automatically or enforcement personnel uses their discretion as to whether a parking ticket should be issued as previously described.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A method of managing parking rights comprising:
receiving, from each of a plurality of users, a request for issuing a parking right, each request containing a unique identifier associated with a parking area and a license plate number identifying a unique vehicle;
storing, in a centralised database, the unique identifier associated with the parking area and the license plate number identifying the unique vehicle of each request;
issuing, based on each received request, a parking right for each of the plurality of users, the parking right including a parking right expiry time by:
linking, in the centralised database, the parking right expiry time, the unique identifier associated with the parking area and the license plate number identifying the unique vehicle for each of the parking right issued;
ascertaining a license plate number of a vehicle for which a parking right status is to be verified;
querying the centralised database by comparing the license plate number of the vehicle for which the parking right status is to be verified, with license plate numbers stored in the centralised database; and
determining if a parking right has been issued that corresponds to the license plate number of the vehicle for which the parking right status is to be verified.

2. The method of claim 28, wherein determining if the parking right has been issued that corresponds to the license plate number of the vehicle for which the parking right status is to be verified comprises:
should the license plate number of the vehicle for which the parking right status is to be verified match one of the license plate numbers stored in the centralised database:
comparing the unique identifier associated with the parking area where the vehicle for which the parking right status is to be verified is located with the unique identifier associated with the parking area linked with the corresponding license plate number stored in the centralised database;
generating a parking right infraction flag should the unique identifier associated with the parking area where the vehicle for which the parking right status is to be verified is located match the unique identifier associated with the parking area linked with the corresponding license plate number stored in the centralised database and the parking right expiry time linked with the corresponding license plate number stored in the centralised database be exceeded;
generating a parking right infraction flag should the unique identifier associated with the parking area where the vehicle for which the parking right status is to be verified is located not match the unique identifier associated with the parking area linked with the corresponding license plate number stored in the centralised database; and
generating a parking right infraction flag should the license plate number of the vehicle for which the parking right status is to be verified not match any of the license plate numbers stored in the centralised database.

3. The method of claim 1, wherein receiving from each of the plurality of users the request for issuing the parking right is received from one of a curb side machine, a land-line phone, a mobile phone, a personal digital assistant, a vehicle navigation system and a web-enabled device.

4. The method of claim 1, wherein receiving from each of the plurality of users the request for issuing the parking right is received from a curb side machine, and comprises:
entering, by the user, on the curb side machine, the unique identifier associated with the parking area, the license plate number identifying the unique vehicle and an amount of parking time to be purchased, the amount of time to be purchased determining the parking right expiry time.

5. The method of claim 4, wherein the curb side machine is dedicated to at least two parking areas.

6. The method of claim 1, wherein receiving, from each of the plurality of users, the request for issuing the parking right comprises:
registering, in the centralised database, the license plate number identifying the unique vehicle and a unique identifier of a communication device of a user to identify the user of the communication device, the license plate number identifying the unique vehicle and the unique identifier of the communication device being linked together in the centralised database; and
requesting the issuance of the parking right, when the unique identifier associated with the parking area in the centralised database is transmitted by the communication device.

7. The method of claim 1, wherein the request for issuing the parking right further contains payment information, the payment information determining the parking right expiry time.

8. The method of claim 1, wherein the request for issuing the parking right further contains a promotional code, the promotional code providing a discount to the user.

9. The method of claim 1, further comprising:
receiving from the user, a request to terminate the parking right; and
modifying, in the centralised database, the parking right expiry time.

10. The method of claim 1, wherein the parking right expiry time depends on a maximum available time for a parking area.

11. The method of claim 1, further comprising:
registering, in the centralised database, a parking permit associated with the license plate number identifying the unique vehicle.

12. The method of claim 1, further comprising:
registering, in the centralised database, contact information of the user associated with the license plate number identifying the unique vehicle; and
sending a notification to the user based on contact information of the user associated with the license plate number identifying the unique vehicle.

13. The method of claim 6, further comprising:
registering, in the centralised database, a second license plate number identifying a second unique vehicle, the second license plate number identifying the second unique vehicle and the unique identifier of the communication device being linked together in the centralised database based on selections made by the user as part of the request.

14. The method of claim 13, further comprising:
registering, in the centralised database, a second unique identifier of a second communication device of the user to identify the user of the second communication device, the license plate number identifying the unique vehicle, the second license plate number identifying the second unique vehicle, and the second unique identifier of the second communication device being linked together in the centralised database.

15. The method of claim 6, further comprising:
registering, in the centralised database, a second unique identifier of a second communication device of the user to identify the user of the second communication device, the license plate number identifying the unique vehicle and the second unique identifier of the second communication device being linked together in the centralised database.

16. The method of claim 1, further comprising:
locating a vehicle, by querying the centralised database to determine a unique identifier associated with a parking area corresponding to the license plate number identifying the vehicle to be located.

17. The method of claim 2, further comprising:
sending a parking ticket to a registered owner of the vehicle for which the parking right status is to be verified should a parking right infraction flag be generated.

18. The method of claim 2, further comprising:
should the parking right infraction flag be generated, allowing enforcement personnel discretion in determining if an infraction identified by the infraction flag warrants a parking ticket; and
sending the parking ticket to a registered owner of the vehicle for which the parking right status is to be verified, should the infraction identified by the infraction flag warrant the parking ticket.

19. The method of claim 1, further comprising:
determining if the vehicle for which the parking right status is to be verified is a stolen vehicle, in the event that the license plate number of the vehicle for which the parking right status is to be verified matches an entry of a list of target vehicles.

20. The method of claim 1, further comprising:
registering, in the centralised database, contact information of the user associated with the license plate number identifying the unique vehicle; and
sending at least one of a promotion and an incentive to the user based on contact information of the user associated with the license plate number identifying the unique vehicle.

21. The method of claim 20, further comprising:
registering, in the centralised database, at least one of information regarding the user associated with the license plate number identifying the unique vehicle and information regarding the unique vehicle; and
sending the at least one of the promotion and the incentive to the user based on the at least one of information regarding the user associated with the license plate number identifying the unique vehicle and information regarding the unique vehicle.

22. A parking rights management system comprising:
a receiving component receiving, from each of a plurality of users, a request for issuing a parking right, each request containing a unique identifier associated with a parking area and a license plate number identifying a unique vehicle;
a centralised database where the unique identifier associated with the parking area and the license plate number identifying the unique vehicle of each request is stored, the receiving component communicating with the centralised database;
a parking right issuing component issuing, based on each received request, a parking right for each of the plurality of users, the parking right including a parking right expiry time, the parking right issuing component linking, in the centralised database, the parking right expiry time, the unique identifier associated with the parking area and the license plate number identifying the unique vehicle for each parking right issued, the parking right issuing component communicating with the centralised database;
a license plate number collecting component collecting a license plate number of a vehicle for which a parking right status is to be verified, the license plate number collecting component communicating with the centralised database; and
an enforcement component querying the centralised database by comparing the license plate number of the vehicle for which the parking right status is to be verified, with license plate numbers stored in the centralised database, the enforcement component further determining if a parking right has been issued that corresponds to the license plate number of the vehicle for which the parking right status is to be verified.

23. The parking rights management system of claim 29, wherein, when the license plate number of the vehicle for which the parking right status is to be verified matches one of the license plate numbers stored in the centralised database, the enforcement component:
compares the unique identifier associated with the parking area where the vehicle for which the parking right status is to be verified is located with the unique identifier associated with the parking area linked with the corresponding license plate number stored in the centralised database;
generates a parking right infraction flag should the unique identifier associated with the parking area where the vehicle for which the parking right status is to be verified is located match the unique identifier associated with the parking area linked with the corresponding license plate number stored in the centralised database and the parking right expiry time linked with the corresponding license plate number stored in the centralised database be exceeded; and
generates a parking right infraction flag should the unique identifier associated with the parking area where the vehicle for which the parking right status is to be verified is located not match the unique identifier associated with the parking area linked with the corresponding license plate number stored in the centralised database; and
the enforcement component generates a parking right infraction flag should the license plate number of the vehicle for which the parking right status is to be verified not match any of the license plate numbers stored in the centralised database.

24. The parking rights management system of claim 23, further comprising at least one of a curb side machine, a land-line phone, a mobile phone, a personal digital assistant, a vehicle navigation system and a web-enabled device for sending the request for issuing the parking right to the receiving component.

25. The parking rights management system of claim 22, wherein the receiving component:
registers, in the centralised database, the license plate number identifying the unique vehicle and a unique identifier of a communication device, the license plate number identifying the unique vehicle and the unique identifier of the communication device being linked together in the centralised database; and
requests the issuance of the parking right, when the unique identifier associated with the parking area in the centralised database is transmitted by the communication device.

26. The parking rights management system of claim 23, wherein the enforcement component sends a parking ticket to a registered owner of the vehicle for which the parking right status is to be verified should a parking right infraction flag be generated.

27. The parking rights management system of claim 22, wherein the license plate number collecting component includes a camera, the camera capturing the license plate number of the vehicle for which the parking right status is to be verified.

28. The method of claim 1, further comprising:
ascertaining a unique identifier associated with a parking area where the vehicle for which the parking right status is to be verified is located.

29. The parking rights management system of claim 22, wherein the license plate number collecting component collects a unique identifier associated with a parking area where the vehicle for which the parking right status is to be verified is located.

30. A method of managing parking rights comprising:
receiving, from each of a plurality of users, a request for issuing a parking right, each request containing a unique identifier associated with a parking area and a license plate number identifying a unique vehicle;
storing, in a centralised database, the unique identifier associated with the parking area and the license plate number identifying the unique vehicle of each request;
issuing, based on each received request, a parking right for each of the plurality of users, the parking right including a parking right expiry time by:
linking, in the centralised database, the parking right expiry time, the unique identifier associated with the parking area and the license plate number identifying the unique vehicle for each of the parking right issued;
querying the centralised database by providing to the centralised database a unique identifier associated with a parking area for which a parking right status of a vehicle parked in the parking area associated with the unique identifier is to be verified; and
returning a license plate number and a parking right expiry time linked to the unique identifier associated with the parking area in the centralised database.

31. The method of claim 30, wherein returning the license plate number and the parking right expiry time linked to the unique identifier associated with the parking area in the centralised database includes returning all license plate numbers and parking right expiry times linked to the unique identifier associated with the parking area in the centralised database.

32. A parking rights management system comprising:
a receiving component receiving, from each of a plurality of users, a request for issuing a parking right, each request containing a unique identifier associated with a parking area and a license plate number identifying a unique vehicle;
a centralised database where the unique identifier associated with the parking area and the license plate number identifying the unique vehicle of each request is stored, the receiving component communicating with the centralised database;
a parking right issuing component issuing, based on each received request, a parking right for each of the plurality of users, the parking right including a parking right expiry time, the parking right issuing component linking, in the centralised database, the parking right expiry time, the unique identifier associated with the parking area and the license plate number identifying the unique vehicle for each parking right issued, the parking right issuing component communicating with the centralised database; and
an enforcement component querying the centralised database by providing to the centralised database a unique identifier associated with a parking area for which a parking right status of a vehicle parked in the parking area associated with the unique identifier is to be verified, the centralised database returning to the enforcement component a license plate number and a parking right expiry time linked to the unique identifier associated with the parking area in the centralised database.

33. The parking rights management system of claim 32, wherein returning to the enforcement component the license plate number and the parking right expiry time linked to the unique identifier associated with the parking area in the centralised database includes returning to the enforcement component all license plate numbers and parking right expiry times linked to the unique identifier associated with the parking area in the centralised database.
